(19) United States
(12) Patent Application Publication
(10) Pub. No.: US 2026/0281022 A1
(43) Pub. Date: Sep. 17, 2026

(54) DELAY INFORMATION COLLECTION APPARATUS, DELAY CONTROL SYSTEM, DELAY INFORMATION COLLECTION METHOD AND PROGRAM

(71) Applicant: NTT, Inc., Tokyo (JP)

(72) Inventors: Yushi KOYASAKO, Musashino-shi, Tokyo (JP); Tomoya HATANO, Musashino-shi, Tokyo (JP); Hirotaka UJIKAWA, Musashino-shi, Tokyo (JP); Hiroshi O, Musashino-shi, Tokyo (JP)

(21) Appl. No.: 18/878,175

(22) PCT Filed: Jun. 29, 2022
(86) PCT No.: PCT/JP2022/025970

§ 371 Date: Dec. 23, 2024

(51) Int. Cl. H04L 43/0864

(52) U.S. Cl. CPC H04L 43/0864

(57) ABSTRACT

A delay information collection device includes a path information acquisition unit that acquires path information regarding a communication path between a control target device and a control device, a delay information acquisition unit that acquires delay information indicating a delay time of communication generated in the communication path from one or a plurality of communication devices existing in the communication path, and a delay information transmission unit that transmits total delay information indicating a total of the delay times based on the delay information acquired by the delay information acquisition unit to the control device that controls the control target device on a basis of the total delay information.

### TECHNICAL FIELD

The present invention relates to a delay information collection device, a delay control system, a delay information collection method, and a program.

### BACKGROUND ART

A communication delay (hereinafter referred to as “network delay”) that is generated in a network may adversely affect control performance in real-time control of an Internet of things (IoT) terminal. For example, as the control performance decreases, the time until the control of the IoT terminal is stabilized may become long or uncontrollable. In general, the greater the distance between the IoT terminal to be controlled (hereinafter referred to as a “control target device”) and a control device that controls the control target device, and the greater the number of communication devices through which communication is performed between the control target device and the control device, the greater the magnitude of the network delay.

In recent years, a technique related to edge computing for reducing the magnitude of the network delay by installing a server in the vicinity of the control target device and performing edge processing has been proposed. In addition, conventionally, a technique of sequentially measuring the delay time and controlling the control target device in real time on the basis of the measured delay time has been proposed. In such a conventional technique, a method of calculating the delay time of communication between the control device and the control target device using a measurement value of a round trip time (RTT) is generally used (see, for example, Patent Literature 1).

Hereinafter, a conventional delay control system will be briefly described. FIG. 21 is a schematic diagram illustrating control of a control target device by a conventional delay control system. As illustrated in FIG. 21, a control target device includes a sensor node and an actuator node, and a control device includes a controller. First, at the beginning of a control cycle, the control device transmits measurement data for measuring an RTT to the control target device by a command such as ping. When receiving the measurement data, the control target device sends response data back to the control device. The control device receives response data transmitted from the control target device. The control device can measure the RTT by measuring a time from transmission of the measurement data to reception of the response data.

Note that, in a case where time synchronization is performed between the control device and the control target device, for example, the RTT can be measured as follows. First, at the beginning of the control cycle, data is transmitted from the sensor node of the control target device to the controller of the control device. As a result, the control device can obtain a value of a delay amount t1 indicating the magnitude of a network delay in communication in a direction from the control target device to the control device. Next, data is transmitted from the controller of the control device to the actuator node of the control target device. As a result, the control device can obtain a value of a delay amount t2 indicating the magnitude of a network delay in communication in a direction from the control device to the control target device. In this case, the RTT is represented by t1+t2.

Then, the control device incorporates delay information based on the value of the RTT into a control algorithm executed by the controller. Note that the control algorithm referred to here is an algorithm executed by the control device to control the control target device in real time. The control device sequentially updates the delay information incorporated in the control algorithm by measuring the RTT for each control cycle.

FIG. 22 is a schematic diagram for describing a basic configuration of a conventional delay control system. As illustrated in FIG. 22, the delay control system includes a control target device, a control device, and a plurality of communication devices. The control target device is, for example, an IoT terminal such as a drone, a sensor, or an actuator. The control device is a server device that controls the control target device in real time. In FIG. 22, only one control device and one control target device are illustrated in order to simplify the description. However, the conventional system is not limited to have this configuration, and one control device may control a plurality of the control target devices in real time.

As illustrated in FIG. 22, the control target device, the plurality of communication devices, and the control device are connected in series. The control target device and the control device communicate with each other via the plurality of communication devices. Note that the number of communication devices via which the communication is performed between the control target device and the control device can be one. Each of the plurality of communication devices sequentially measures a processing time of communication processing executed by the each communication device. Then, each of the plurality of communication devices transmits information indicating the measured processing time to the control device. As a result, the control device can sequentially acquire information (hereinafter referred to as “delay information”) indicating the processing time of the communication processing executed by each communication device from all the communication devices. The control device sets a control algorithm to be executed by the control device each time acquiring the delay information from all the communication devices. Specifically, the control device updates the delay information incorporated in the control algorithm each time with new delay information sequentially acquired.

Note that the network delay generated in the communication between the control target device and the control device is not necessarily limited to the delay generated only by the communication processing executed by the communication device. However, here, to simplify the description, the delay time of the network delay caused in the communication between the control target device and the control device is assumed to be obtained by integrating the processing times of the communication processing executed by the respective communication devices.

FIG. 23 is a block diagram illustrating an example of a functional configuration of a conventional delay control system. As illustrated in FIG. 23, the delay control system includes, for example, a control target device, a control server, a communication server, and a white box switch. The control target device is, for example, an IoT terminal and is a device managed by a user. The control server, the communication server, and the white box switch are devices managed by a telecommunications operator (on an office building side). The control system is a system for controlling the control target device in real time by edge computing by the telecommunications operator.

As illustrated in FIG. 23, the control server includes a delay information reception unit and an update unit. Note that the control server is a device corresponding to the control device of the control system illustrated in FIG. 22. The communication server includes a processing time measurement unit, a monitoring unit, and a delay information transmission unit. The white box switch includes a processing time measurement unit, a monitoring unit, and a delay information transmission unit. Note that the communication server and the white box switch are devices corresponding to the communication device of the control system illustrated in FIG. 22.

The control server is a server device that controls the control target device in real time. Note that, to simplify the description, FIG. 23 illustrates a configuration of the control system in which one control server controls only one control target device in real time. However, the conventional system is not limited to have this configuration, and one control server may control a plurality of the control target devices in real time. As illustrated in FIG. 23, the control target device, the communication server, the white box switch, and the control server are connected in series. The control target device and the control server communicate with each other via the communication server and the white box switch.

The processing time measurement unit of the communication server sequentially measures a processing time of communication processing executed by the its own communication server. The monitoring unit of the communication server determines whether to transmit delay information indicating the processing time to the control server on the basis of the processing time measured by the processing time measurement unit and a cycle of measurement by the processing time measurement unit. The delay information transmission unit of the communication server transmits the delay information to the control server in a case where the monitoring unit determines to transmit the delay information.

The configurations of the processing time measurement unit, the monitoring unit, and the delay information transmission unit of the white box switch are the same as the configurations of the processing time measurement unit, the monitoring unit, and the delay information transmission unit of the communication server, respectively. The processing time measurement unit of the white box switch sequentially measures the processing time of the communication processing executed by the its own white box switch. The monitoring unit of the white box switch determines whether to transmit the delay information indicating the processing time to the control server on the basis of the processing time measured by the processing time measurement unit and the cycle of measurement by the processing time measurement unit. The delay information transmission unit of the white box switch transmits the delay information to the control server in the case where the monitoring unit determines to transmit the delay information.

The delay information reception unit of the control server receives the delay information transmitted from each of the communication server and the white box switch. The update unit of the control server sequentially updates the delay information incorporated in an control algorithm executed by the control server with new delay information sequentially acquired by the delay information reception unit. Then, a controller (not illustrated) included in the control server controls the control target device in real time by the control algorithm with the updated delay information.

### CITATION LIST

### Patent Literature

Patent Literature 1: JP 2020-021410 A

### SUMMARY OF INVENTION

### Technical Problem

As described above, in remote control of a control target device such as an IoT terminal in consideration of a delay in a communication path, a method of considering a processing time of communication processing in a communication device existing in the communication path as a delay has been conventionally known (for example, Patent Literature 1). In such a conventional method, a measurement value of an RTT is generally used as delay information transmitted from the communication device to a control device. Then, in such a conventional method, the delay information indicating a delay generated in the communication device (generally managed by a telecommunications operator) existing in a communication network needs to be acquired by the control device (generally managed by a user).

However, in general, since the control device is a device managed by the user, there is a case where the control device does not have an interface capable of directly communicating and connecting with the communication device managed by the telecommunications operator. Therefore, there is a problem that it is practically difficult for the control device to directly communicate with the communication device existing in the communication path between the control device and the control target device, acquire the delay information from the communication device, and perform the remote control of the control target device by the above-described conventional method.

In view of the above circumstances, an object of the present invention is to provide a delay information collection device, a delay control system, a delay information collection method, and a program capable of remotely controlling a control target device in consideration of a delay generated in a communication path even in a case where a control device cannot directly communicate with a communication device existing in the communication path between the control device and the control target device.

### Solution to Problem

One aspect of the present invention is a delay information collection device including: a path information acquisition unit that acquires path information regarding a communication path between a control target device and a control device; a delay information acquisition unit that acquires delay information indicating a delay time of communication generated in the communication path from one or a plurality of communication devices existing in the communication path; and a delay information transmission unit that transmits total delay information indicating a total of the delay times based on the delay information acquired by the delay information acquisition unit to the control device that controls the control target device on a basis of the total delay information.

Further, one aspect of the present invention is a delay control system including a control device and a delay information collection device, the control device including: a path information transmission unit that transmits, to the delay information collection device, path information regarding a communication path between a control target device to be controlled and the control device; a total delay information acquisition unit that acquires, from the delay information collection device, total delay information indicating a total of delay times of communication generated in the communication path; and a control unit that controls the control target device on a basis of the total delay information acquired by the total delay information acquisition unit, and the delay information collection device including: a path information acquisition unit that acquires path information transmitted from the control device; a delay information acquisition unit that acquires delay information indicating the delay time from one or a plurality of communication devices existing in the communication path; and a total delay information transmission unit that transmits, to the control device, the total delay information indicating a total of the delay times based on the delay information acquired by the delay information acquisition unit.

Further, one aspect of the present invention is a delay information collection method by a computer of a delay information collection device, the delay information collection method including: a path information acquisition step of acquiring path information regarding a communication path between a control target device and a control device; a delay information acquisition step of acquiring delay information indicating a delay time of communication generated in the communication path from one or a plurality of communication devices existing in the communication path; and a delay information transmission step of transmitting total delay information indicating a total of the delay times based on the delay information acquired by the delay information acquisition step to the control device that controls the control target device on a basis of the total delay information.

Further, one aspect of the present invention is a program for causing a computer to execute: a path information acquisition step of acquiring path information regarding a communication path between a control target device and a control device; a delay information acquisition step of acquiring delay information indicating a delay time of communication generated in the communication path from one or a plurality of communication devices existing in the communication path; and a delay information transmission step of transmitting total delay information indicating a total of the delay times based on the delay information acquired by the delay information acquisition step to the control device that controls the control target device on a basis of the total delay information.

### Advantageous Effects of Invention

According to the present invention, it is possible to remotely control a control target device in consideration of a delay generated in a communication path even in a case where a control device cannot directly communicate with a communication device existing in the communication path between the control device and the control target device.

### BRIEF DESCRIPTION OF DRAWINGS

FIG. 1 is an overall configuration diagram of a delay control system 1 according to a first embodiment of the present invention.

FIG. 2 is a block diagram illustrating a functional configuration of a delay information collection App 41 of a delay information collection device 40 according to the first embodiment of the present invention.

FIG. 3 is a diagram illustrating an example of a configuration of a communication network and the delay control system.

FIG. 4 is a diagram illustrating an example of a path information master stored in a path delay information DB 412 according to the first embodiment of the present invention.

FIG. 5 is a diagram illustrating an example of delay information stored in the path delay information DB 412 according to the first embodiment of the present invention.

FIG. 6 is a flowchart illustrating an operation of the delay control system 1 according to the first embodiment of the present invention.

FIG. 7 is a block diagram illustrating a functional configuration of a delay information collection App 41a of a delay information collection device 40 according to a second embodiment of the present invention.

FIG. 8 is a flowchart illustrating an operation of a delay control system 1a according to the second embodiment of the present invention.

FIG. 9 is a diagram illustrating an example of a configuration of a communication network and the delay control system.

FIG. 10 is a diagram illustrating an example of a path information master stored in a path delay information DB 412b according to the third embodiment of the present invention.

FIG. 11 is a diagram illustrating an example of delay information stored in the path delay information DB 412b according to the third embodiment of the present invention.

FIG. 12 is a block diagram illustrating an example of a network configuration of a delay control system according to an embodiment of the present invention.

FIG. 13 is a block diagram illustrating an example of a network configuration of a delay control system according to an embodiment of the present invention.

FIG. 14 is a block diagram illustrating an example of a network configuration of a delay control system according to an embodiment of the present invention.

FIG. 15 is a block diagram illustrating an example of a network configuration of a delay control system according to an embodiment of the present invention.

FIG. 16 is a block diagram illustrating an example of a network configuration of a delay control system according to an embodiment of the present invention.

FIG. 17 is a block diagram illustrating an example of a network configuration of a delay control system according to an embodiment of the present invention.

FIG. 18 is a block diagram illustrating an example of a network configuration of a delay control system according to an embodiment of the present invention.

FIG. 19 is a block diagram illustrating an example of a network configuration of a delay control system according to an embodiment of the present invention.

FIG. 20 is a block diagram illustrating an example of a network configuration of a delay control system according to an embodiment of the present invention.

FIG. 21 is a schematic diagram illustrating control of a control target device by a conventional delay control system.

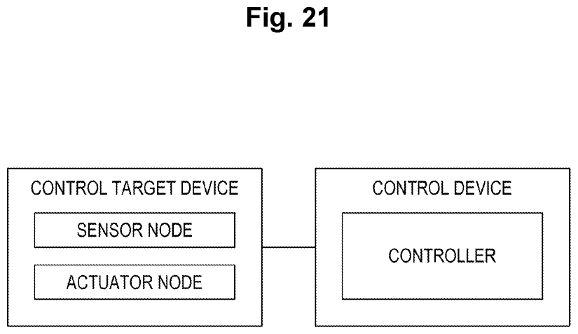

FIG. 22 is a schematic diagram for describing a basic configuration of a conventional delay control system.

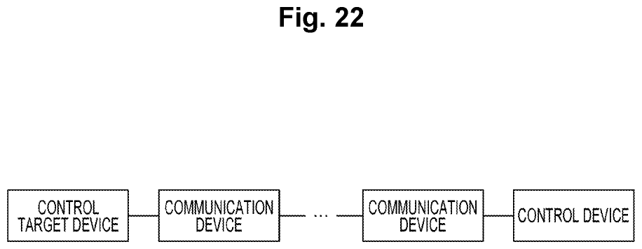

FIG. 23 is a block diagram illustrating an example of a functional configuration of a conventional delay control system.

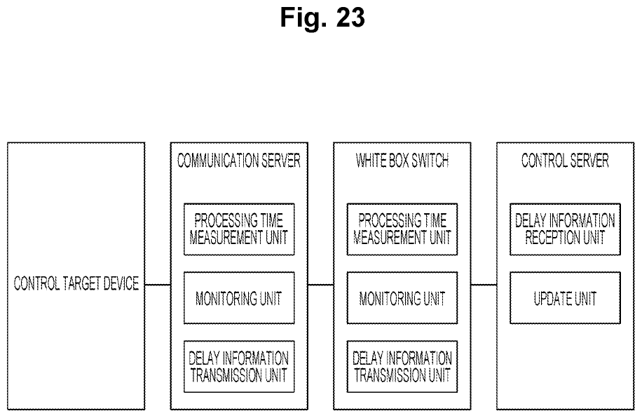

### DESCRIPTION OF EMBODIMENTS

Hereinafter, a delay information collection device, a delay control system, a delay information collection method, and a program according to embodiments will be described with reference to the drawings.

### First Embodiment

Hereinafter, a delay control system 1 according to a first embodiment of the present invention will be described.

### Configuration of Delay Control System

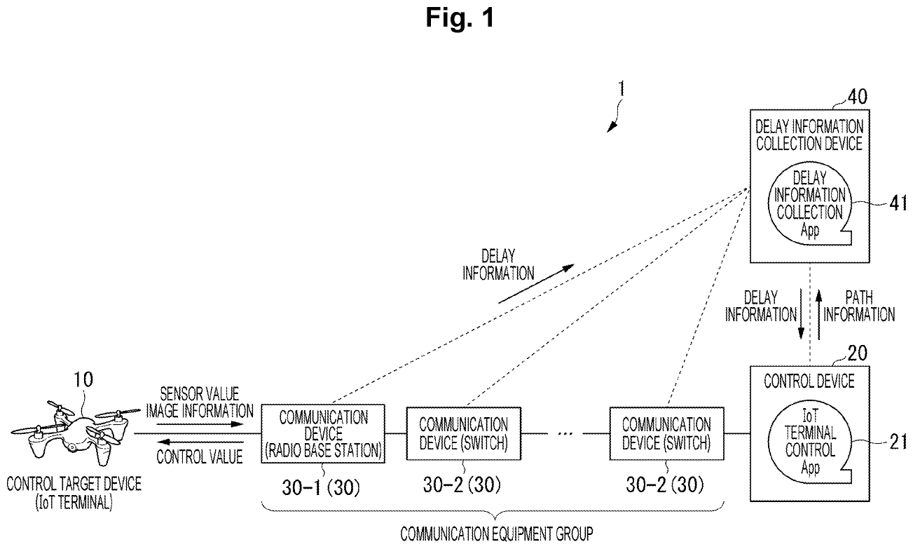

An overall configuration of the delay control system 1 will be described below. FIG. 1 is an overall configuration diagram of the delay control system 1 according to the first embodiment of the present invention. As illustrated in FIG. 1, the delay control system 1 includes a control target device 10, a control device 20, a plurality of communication devices 30, and a delay information collection device 40.

The control target device 10 is, for example, an IoT terminal such as a drone, a sensor, or an actuator. Furthermore, the control device 20 is, for example, a server device (information processing device) such as a general-purpose computer that controls the control target device 10 in real time. Note that, in FIG. 1, only one control device 20 and one control target device 10 are illustrated in order to simplify the description. However, the system is not limited to have this configuration, and for example, one control device 20 may control a plurality of the control target devices 10 in real time.

As illustrated in FIG. 1, the control target device 10, the plurality of communication devices 30, and the control device 20 are connected in series. The control target device 10 and the control device 20 communicate with each other via the plurality of communication devices 30. Note that the number of communication devices 30 (communication devices 30 present in a communication path) via which communication is performed between the control target device 10 and the control device 20 can be one.

FIG. 1 illustrates, as an example, three communication devices 30. One is a communication device 30-1 and two are communication devices 30-2. The communication device 30-1 is a radio base station that wirelessly communicates with and connects to the control target device 10. The communication device 30-2 is a switch that switches a wired communication path. Note that the communication device 30 is not limited to a radio base station and a switch, and includes all devices that exist in a communication path between the control device 20 and the control target device 10 and perform communication processing that can cause delay generation. Note that, in the following description, in a case where it is not necessary to distinguish and describe the communication device 30-1 and the communication device 30-2, they are simply referred to as “communication device(s) 30”.

Each of the plurality of communication devices 30 sequentially measures a processing time of communication processing executed by the each communication device 30.

Then, each of the plurality of communication devices 30 transmits delay information indicating the measured processing time to the delay information collection device 40. Note that the communication device 30 may transmit the delay information in response to a request from the delay information collection device 40, or may voluntarily transmit the delay information to the delay information collection device 40 periodically, for example.

The delay information collection device 40 is, for example, an information processing device such as a general-purpose computer. As illustrated in FIG. 1, a delay information collection application 41 (hereinafter referred to as a “delay information collection App 41”) is installed in the delay information collection device 40.

The delay information collection App 41 is an application that collects the delay information transmitted from each of the communication devices 30 and outputs information based on the collected delay information to the control device 20.

The delay information collection App 41 acquires the delay information transmitted from each of the plurality of communication devices 30. The delay information collection device 40 acquires the delay information from all the communication devices 30, for example. The delay information collection App 41 adds up the acquired delay information and outputs a result to the control device 20. As a result, the control device 20 can sequentially acquire the information indicating a sum of the processing times (delay times) of the communication processing executed by the respective communication devices 30 existing in the communication path via the delay information collection App 41 of the delay information collection device 40.

Note that the delay information collection App 41 may voluntarily transmit the delay information to the control device 20 or may transmit the delay information in response to a request from the control device 20. In a case where the delay information collection device 40 voluntarily transmits the delay information to the control device 20, for example, the delay information collection device may transmit the delay information when having collected the delay information from all the communication devices 30, or may transmit the delay information periodically.

The control device 20 is a server device (information processing device) that controls the control target device 10 (IoT terminal) in real time. As illustrated in FIG. 1, an IoT terminal control application 21 (hereinafter referred to as an “IoT terminal control App 21”) is installed in the control device 20. The IoT terminal control App 21 is an application that executes a control algorithm for controlling the control target device 10 in real time.

The IoT terminal control App 21 sequentially acquires the delay information from all the communication devices 30 collected by the delay information collection App 41 from the delay information collection device 40.

The IoT terminal control App 21 sets a control algorithm to be executed by the IoT terminal control App 21 each time acquiring the delay information. Specifically, the IoT terminal control App 21 updates the delay information incorporated in the control algorithm each time with new delay information sequentially acquired.

With such a configuration, even if the delay time of the delay generated in each of the communication devices 30 changes, the IoT terminal control App 21 can execute appropriate control of the control target device 10 in real time following the change in the delay time.

In addition, for example, in a case where the control device 20 controls a plurality of the control target devices 10 in real time, the control device 20 needs to acquire the delay information for each control target device 10 targeted for updating the delay information incorporated in the control algorithm. As illustrated in FIG. 1, the IoT terminal control App 21 of the control device 20 transmits, to the delay information collection device 40, path information indicating a communication path between the control target device 10 targeted for updating the delay information and the control device 20.

The delay information collection App 41 of the delay information collection device 40 acquires the path information transmitted from the IoT terminal control App 21. The delay information collection App 41 specifies one or a plurality of the communication devices 30 existing in the communication path corresponding to the acquired path information. The delay information collection App 41 collects the delay information from each of the identified communication devices 30. The delay information collection App 41 adds up the delay times based on the collected delay information and outputs a result to the control device 20.

The IoT terminal control App 21 of the control device 20 acquires delay information (total delay information) indicating a total of the delay times in all the communication devices 30 existing in the communication path between the control target device 10 to be controlled and the control device 20, which has been collected by the delay information collection App 41, from the delay information collection device 40. The IoT terminal control App 21 sets a control algorithm to be executed by the IoT terminal control App 21 each time acquiring the delay information. Specifically, the IoT terminal control App 21 updates the delay information incorporated in the control algorithm each time with new delay information sequentially acquired.

With such a configuration, even if the delay time of the delay generated in each of the communication devices 30 existing in the communication path between the control target device 10 to be controlled and the control device 20 changes, the IoT terminal control App 21 can execute appropriate control in real time for each control target device 10 to be controlled following the change in the delay time.

Note that the network delay generated in the communication path between the control target device 10 and the control device 20 is not necessarily limited to the delay generated only by the communication processing executed by the communication device 30. However, here, to simplify the description, the delay time of the network delay caused in the communication path between the control target device 10 and the control device 20 is assumed to be obtained by integrating the processing times of the communication processing executed by the respective communication devices 30. Note that, if necessary, for example, a delay time of another network delay such as a propagation time may be set in advance as a fixed value, and the delay time of the another network delay may be added to the above-described integrated time.

### Configuration of Delay Information Collection App

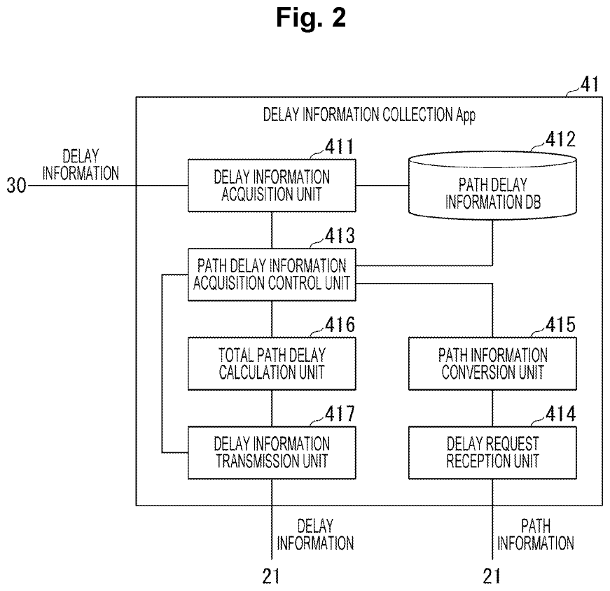

Hereinafter, a configuration of the delay information collection App 41 of the delay information collection device 40 will be described. FIG. 2 is a block diagram illustrating a functional configuration of the delay information collection App 41 of the delay information collection device 40 according to the first embodiment of the present invention.

As illustrated in FIG. 2, the delay information collection App 41 includes a delay information acquisition unit 411, a path delay information database 412 (hereinafter referred to as a “path delay information DB 412”), a path delay information acquisition control unit 413, a delay information request reception unit 414, a path information conversion unit 415, a total path delay calculation unit 416, and a delay information transmission unit 417.

The delay information acquisition unit 411 acquires the delay information transmitted from each of the plurality of communication devices 30. A path identifier (ID) is assigned to the delay information transmitted from the communication device 30. The path ID is an identifier indicating a specific range of the communication path between the control target device 10 and the control device 20. The delay information collection App 41 can recognize the network delay for each specific range of the communication path by acquiring the delay information and the path ID.

In the first embodiment, since it is assumed that the network delay is generated only in the communication device 30 as described above, the path ID corresponds to an identifier for identifying the communication device 30. Therefore, in the first embodiment, the delay information collection App 41 can recognize the network delay for each communication device 30.

The delay information acquisition unit 411 stores information in which the acquired delay information is associated with the path information in the path delay information DB 412.

The delay information request reception unit 414 (path information acquisition unit) acquires a delay information request transmitted from the IoT terminal control App 21 of the control device 20. The delay information request includes the path information for specifying the communication path between the control target device 10 to be controlled by the IoT terminal control App 21 and the control device 20. The delay information request reception unit 414 outputs the acquired path information to the path information conversion unit 415.

Note that the path information may be any information as long as the information can specify the communication path between the control target device 10 and the control device 20. For example, the path information may be identification information for identifying the control target device 10 as long as the path information can specify the communication path on the basis of the identification information for identifying the control target device 10, such as an IP address or a MAC address.

The path information conversion unit 415 acquires the path information output from the delay information request reception unit 414. The path information conversion unit 415 specifies the communication path between the control target device 10 to be controlled by the IoT terminal control App 21 and the control device 20 on the basis of the acquired path information. Then, the path information conversion unit 415 specifies the path ID corresponding to each of ranges (communication devices 30) constituting the specified communication path. The path information conversion unit 415 outputs the specified one or more path IDs (hereinafter referred to as a “path ID group”) to the path delay information acquisition control unit 413.

The path delay information acquisition control unit 413 acquires the path ID group output from the path information conversion unit 415. The path delay information acquisition control unit 413 refers to the path delay information DB 412 and acquires the delay information associated with each of the path IDs included in the acquired path ID group.

Note that the delay information acquisition unit 411 may directly output the information in which the acquired delay information and the path ID are associated with each other to the path delay information acquisition control unit 413. In this case, the path delay information acquisition control unit 413 acquires the delay information associated with each of the path IDs included in the acquired path ID group on the basis of the delay information acquired from the delay information acquisition unit 411 and the path ID.

Note that from which of the path delay information DB 412 and the delay information acquisition unit 411 the path delay information acquisition control unit 413 acquires the delay information may be determined in response to a request from the IoT terminal control App 21 of the control device 20, for example. For example, in a case where the request from the IoT terminal control App 21 is a request that requires more real-time property, it is preferable to directly acquire the delay information from the delay information acquisition unit 411, otherwise, it is preferable to acquire the delay information from the path delay information DB 412.

In a case where the path ID group acquired from the path information conversion unit 415 includes a plurality of path IDs (that is, in a case where a plurality of the communication devices 30 exists in the communication path between the control target device 10 to be controlled by the IoT terminal control App 21 and the control device 20), the path delay information acquisition control unit 413 outputs the delay information associated with each of the path IDs to the total path delay calculation unit 416.

Further, in a case where the path ID group acquired from the path information conversion unit 415 includes only one path ID (that is, only one communication device 30 exists in the communication path between the control target device 10 to be controlled by the IoT terminal control App 21 and the control device 20), the path delay information acquisition control unit 413 outputs the delay information associated with the path ID to the delay information transmission unit 417. Alternatively, in a case where there is a request from the control device 20 to transmit the delay information to the IoT terminal control App 21 of the control device 20 without adding up the delay information, the path delay information acquisition control unit 413 outputs the delay information associated with the path ID to the delay information transmission unit 417.

The total path delay calculation unit 416 acquires a plurality of pieces of the delay information (associated with the respective path IDs) output from the path delay information acquisition control unit 413. The total path delay calculation unit 416 adds up the delay times indicated by the respective pieces of acquired delay information. The total path delay calculation unit 416 outputs the delay information (total delay information) indicating the added delay time to the delay information transmission unit 417 (total delay information transmission unit).

The delay information transmission unit 417 acquires the delay information output from the path delay information acquisition control unit 413 or the total path delay calculation unit 416. The delay information transmission unit 417 transmits the acquired delay information to the IoT terminal control App 21 of the control device 20.

The IoT terminal control App 21 acquires the delay information transmitted from the delay information transmission unit 417. The IoT terminal control App 21 sets a control algorithm to be executed by the IoT terminal control App 21 each time acquiring the delay information. Specifically, the IoT terminal control App 21 updates the delay information incorporated in the control algorithm each time with the new delay information (total delay information) sequentially acquired. For example, the IoT terminal control App 21 updates the setting of the control algorithm such that the delay time based on the acquired delay information (total delay information) is considered.

With such a configuration, even if the delay time of the delay generated in each of the communication devices 30 existing in the communication path between the control target device 10 to be controlled and the control device 20 changes, the IoT terminal control App 21 can execute appropriate control in real time for each control target device 10 to be controlled following the change in the delay time.

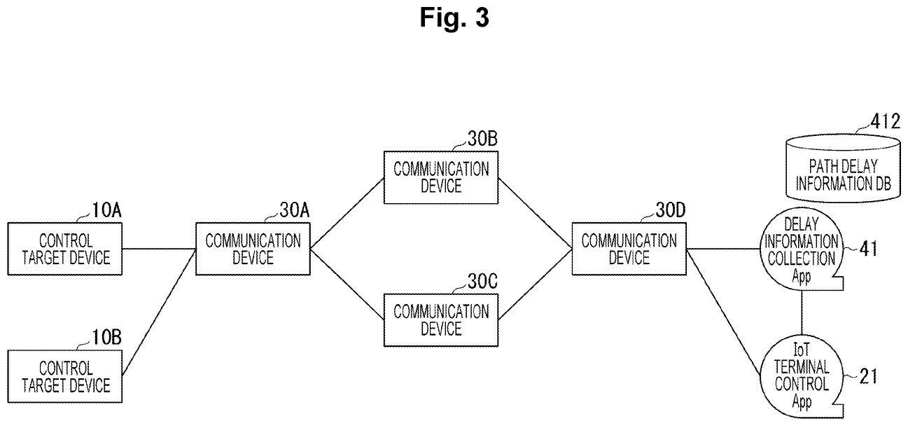

Hereinafter, to make the description easy to understand, delay information collection processing by the delay information collection App 41 of the delay information collection device 40 will be described with a specific example. FIG. 3 is a diagram illustrating an example of a configuration of a communication network and the delay control system.

As illustrated in FIG. 3, the IoT terminal control App 21 can control a control target device 10A and a control target device 10B. Furthermore, as illustrated in FIG. 3, communication devices 30A to 30D exist in the communication paths between the IoT terminal control App 21 (the control device 20), and the control target device 10A and the control target device 10B.

As illustrated in FIG. 3, the control target device 10A and the control target device 10B are connected to the communication device 30A. The communication device 30A is connected to the communication device 30B and the communication device 30C. The communication device 30B and the communication device 30C are connected to the communication device 30D. The communication device 30D is connected to the IoT terminal control App 21 (control device 20) and the delay information collection App 41 (delay information collection device 40). The delay information collection App 41 includes the path delay information DB 412.

The path delay information DB 412 stores in advance information (hereinafter referred to as a “path information master”) in which the identification information for identifying the control target device 10 and identification information (that is, the above-described path ID group) for identifying the communication device 30 existing in the communication path between the control target device 10 and the control device 20 are associated with each other. Here, it is assumed that the path information master is acquired in advance by, for example, another system (not illustrated) or the like and stored in the path delay information DB 412.

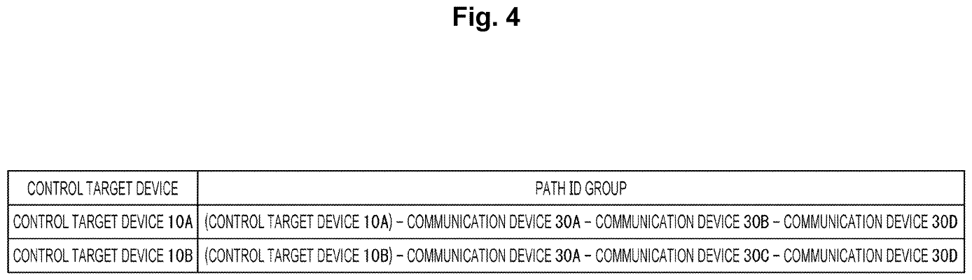

FIG. 4 is a diagram illustrating an example of the path information master stored in the path delay information DB 412 according to the first embodiment of the present invention. As illustrated in FIG. 4, the path ID group indicating the communication path such as (control target device 10A)—“communication device 30A”—“communication device 30B”—“communication device 30D” is associated with the identification information (in FIG. 4, a character string “control target device 10A”) for identifying the control target device 10A. In FIG. 4, each of character strings of “communication device 30A”, “communication device 30B”, and “communication device 30D” is the path ID.

The path delay information DB 412 also stores the information in which the path ID and the delay information are associated with each other. The delay information is sequentially acquired from each of the communication devices 30 and updated by the delay information collection App 41.

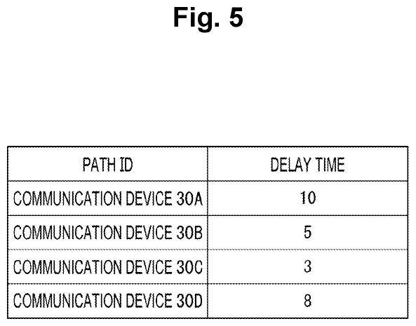

FIG. 5 is a diagram illustrating an example of the delay information stored in the path delay information DB 412 according to the first embodiment of the present invention. As illustrated in FIG. 4, the delay information is information in which information indicating the delay time is associated with the path ID.

The information indicating the delay time included in the delay information is, for example, information indicating the delay time of the delay generated in the communication processing executed by each communication device 30. As illustrated in FIG. 4, for example, the delay time of “10” is associated with the path ID of “communication device 30A”. This indicates that the delay time (at that time) of the delay generated in the communication processing executed by the communication device 30A is 10 (for example, 10 milliseconds).

Furthermore, as illustrated in FIG. 4, for example, the delay time of “5” is associated with the path ID of “communication device 30B”. This indicates that the delay time (at that time) of the delay generated in the communication processing executed by the communication device 30B is 5 (for example, 5 milliseconds).

Hereinafter, a flow of delay information collection processing will be described. First, the IoT terminal control App 21 transmits the path information including the identification information for identifying the control target device 10 to be controlled to the delay information collection App 41. As an example, here, it is assumed that the IoT terminal control App 21 transmits the path information including the identification information indicating the control target device 10A to the delay information collection App 41.

The delay information collection App 41 acquires the path information transmitted from the IoT terminal control App 21. The delay information collection App 41 specifies the identification information (identifying the control target device 10) included in the acquired path information. The delay information collection App 41 refers to the path delay information DB 412 and acquires the path ID group corresponding to the specified identification information.

As described above, here, the identification information included in the path information is the identification information indicating the control target device 10A. The delay information collection App 41 acquires “(control target device 10A)—communication device 30A—communication device 30B—communication device 30D”, which is the path ID group corresponding to the control target device 10A illustrated in FIG. 4, for example.

Next, the delay information collection App 41 refers to the path delay information DB 412 and acquires the delay information corresponding to each of the path IDs included in the acquired path ID group. Specifically, the delay information collection App 41 acquires, for example, “10” that is a value of the delay time corresponding to “communication device 30A”, “5” that is a value of the delay time corresponding to “communication device 30B”, and “8” that is a value of the delay time corresponding to “communication device 30D” illustrated in FIG. 3.

The delay information collection App 41 adds up the values of the delay times indicated by the acquired delay information. Specifically, the delay information collection App 41 obtains the value of “23” that is a result of adding up the values of the delay times included in the respective pieces of delay information described above. The delay information collection App 41 transmits the delay information (total delay information) indicating the added delay time to the IoT terminal control App 21.

The IoT terminal control App 21 acquires the delay information transmitted from the delay information collection App 41. The IoT terminal control App 21 updates the delay information incorporated in the control algorithm each time with the acquired new delay information.

Specifically, the IoT terminal control App 21 updates the setting of the control algorithm so as to control the control target device 10A in consideration of the value of “23” (for example, 23 milliseconds) that is the delay time indicated by the acquired delay information.

With such a configuration, even if the delay time of the delay generated in each of the communication device 30A, the communication device 30B, and the communication device 30D existing in the communication path between the control target device 10A to be controlled and the control device 20 changes, the IoT terminal control App 21 can execute appropriate control of the control target device 10A in real time following the change in the delay time.

### Operation of Delay Control System

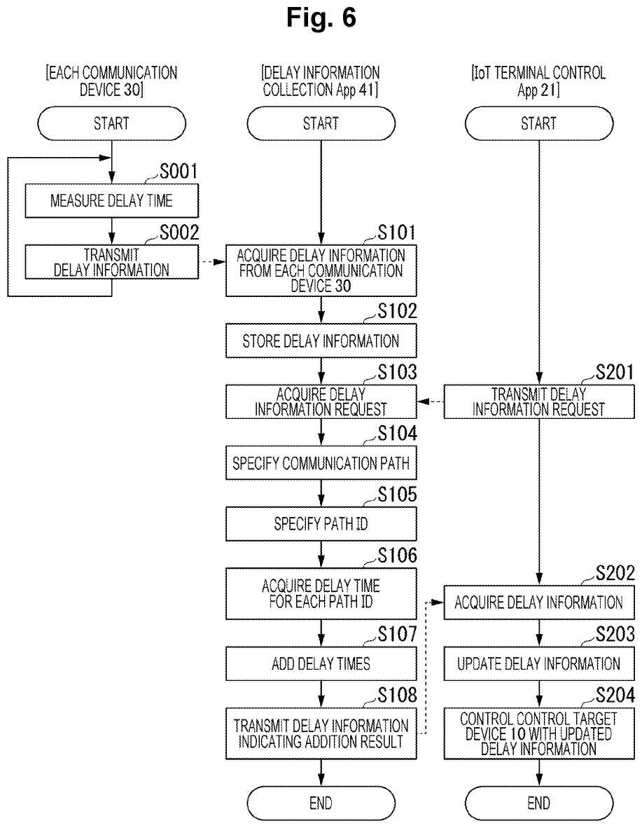

Hereinafter, an example of an operation of the delay control system 1 will be described. FIG. 6 is a flowchart illustrating an operation of the delay control system 1 according to the first embodiment of the present invention. The operation of the delay control system 1 illustrated in the flowchart of FIG. 6 is started when the system is activated, for example.

Each of the plurality of communication devices 30 measures the processing time (delay time) of the communication processing executed by the each communication device, for example, periodically (for example, every 1 second) (step S001). Each time measuring the delay time, each of the plurality of communication devices 30 transmits the delay information to the delay information collection device 40 (step S002). As described above, the delay information includes the measured delay time and the path ID that is the identification information for identifying the communication device 30 that has measured the delay time.

The delay information acquisition unit 411 of the delay information collection App 41 acquires the delay information transmitted from each of the plurality of communication devices 30 (step S101). The delay information acquisition unit 411 stores the acquired delay information in the path delay information DB 412 (step S102).

The IoT terminal control App 21 of the control device 20 transmits the delay information request to the delay information collection App 41 of the delay information collection device 40 (step S201). As described above, the delay information request includes the path information for specifying the communication path between the control target device 10 to be controlled by the IoT terminal control App 21 and the control device 20 (for example, the identification information for identifying the control target device 10).

The delay information request reception unit 414 of the delay information collection App 41 acquires the delay information request transmitted from the IoT terminal control App 21 of the control device 20 (step S103). The delay information request reception unit 414 outputs the acquired path information to the path information conversion unit 415.

The path information conversion unit 415 acquires the path information output from the delay information request reception unit 414. The path information conversion unit 415 refers to the path delay information DB 412 and specifies the communication path between the control target device 10 to be controlled by the IoT terminal control App 21 and the control device 20, the communication path corresponding to the acquired path information (for example, the identification information for identifying the control target device 10) (step S104). Then, the path information conversion unit 415 specifies the path ID corresponding to each of the ranges (the communication devices 30 in the present embodiment) constituting the specified communication path (step S105). The path information conversion unit 415 outputs the specified one or more path IDs (path ID group) to the path delay information acquisition control unit 413.

The path delay information acquisition control unit 413 acquires the path ID group output from the path information conversion unit 415. The path delay information acquisition control unit 413 refers to the path delay information DB 412 and acquires the delay time associated with each of the path IDs included in the acquired path ID group (step S106). The path delay information acquisition control unit 413 outputs the information indicating the delay time associated with each path ID to the total path delay calculation unit 416.

The total path delay calculation unit 416 acquires the information indicating the plurality of delay times (associated with the respective path IDs) output from the path delay information acquisition control unit 413. The total path delay calculation unit 416 adds up the delay times indicated by the respective pieces of acquired information (step S107). The total path delay calculation unit 416 outputs the delay information (total delay information) indicating the added delay time to the delay information transmission unit 417.

The delay information transmission unit 417 acquires the delay information output from the path delay information acquisition control unit 413 or the total path delay calculation unit 416. The delay information transmission unit 417 transmits the acquired delay information to the IoT terminal control App 21 of the control device 20 (step S108).

The IoT terminal control App 21 of the control device 20 acquires the delay information transmitted from the delay information transmission unit 417 (step S202).

The IoT terminal control App 21 sets a control algorithm to be executed by the IoT terminal control App 21 each time acquiring the delay information. Specifically, the IoT terminal control App 21 updates the delay information incorporated in the control algorithm each time with the new delay information sequentially acquired (step S203). For example, the IoT terminal control App 21 updates the setting of the control algorithm such that the delay time based on the acquired delay information is considered.

The IoT terminal control App 21 controls the control target device 10 by the control algorithm using the updated delay information (step S204). Thus, the operation of the delay control system 1 illustrated in the flowchart of FIG. 6 ends.

As described above, the delay control system 1 according to the first embodiment of the present invention is a system for the control device 20 to remotely control the control target device 10 such as the IoT terminal in consideration of the delay generated in the communication path. In general, since the control device 20 is a device managed by the user, the control device does not have an interface capable of directly communicating and connecting with the communication device 30 managed by the telecommunications operator and present in the communication path.

However, the delay control system 1 according to the first embodiment of the present invention includes the delay information collection device 40 that collects the delay information from each communication device 30 instead of the device managed by the user. With such a configuration, the delay control system 1 according to the first embodiment of the present invention can perform remote control of the control target device 10 in consideration of the delay generated in the communication path even in the case where the control device 20 cannot directly communicate with the communication device 30 existing in the communication path between the control device 20 and the control target device 10.

### Second Embodiment

Hereinafter, a delay control system 1a according to a second embodiment of the present invention will be described.

In the above-described delay control system 1 according to the first embodiment, each of the communication devices 30 is configured to voluntarily transmit the delay information to the delay information collection device 40. In contrast, in the delay control system 1a according to the second embodiment to be described below, first, a delay information collection App 41a requests each of communication devices 30 existing in a communication path based on path information specified by an IoT terminal control App 21 to transmit delay information. Then, each of the communication devices 30 is configured to transmit the delay information to the delay information collection App 41a in response to the transmission request of the delay information.

That is, in the above-described delay control system 1 according to the first embodiment, the delay information is transmitted from each of the communication devices 30 to the delay information collection App 41 by a push-type information transmission method. In contrast, in the delay control system 1a according to the second embodiment to be described below, the delay information is transmitted from each of the communication devices 30 to the delay information collection App 41a by a pull-type information transmission method in response to the request from the delay information collection App 41a.

With such a configuration, the delay control system 1a according to the second embodiment can be configured to acquire only the delay information of a necessary communication device 30 at necessary timing, for example. As a result, the delay control system 1a according to the second embodiment can reduce a storage capacity of a path delay information DB 412 or reduce an amount of communication between each of the communication devices 30 and a delay information collection device 40, for example.

### Configuration of Delay Control System

An overall configuration diagram of the delay control system 1a according to the second embodiment is similar to the overall configuration diagram of the above-described delay control system 1 according to the first embodiment illustrated in FIG. 1, and thus description thereof will be omitted.

### Configuration of Delay Information Collection App

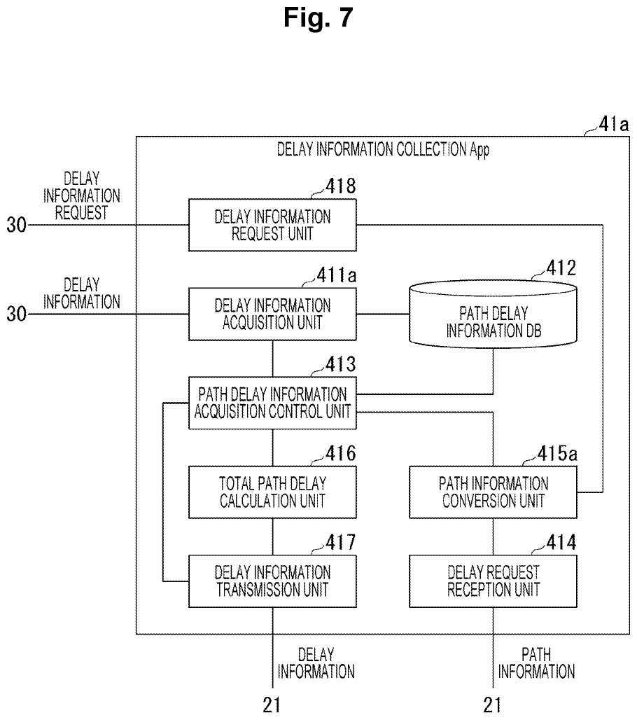

Hereinafter, a configuration of the delay information collection App 41a of the delay information collection device 40 of the delay control system 1a according to the second embodiment will be described. FIG. 7 is a block diagram illustrating a functional configuration of a delay information collection App 41a of a delay information collection device 40 according to a second embodiment of the present invention.

As illustrated in FIG. 7, the delay information collection App 41a includes a delay information acquisition unit 411a, a path delay information DB 412, a path delay information acquisition control unit 413, a delay information request reception unit 414, a path information conversion unit 415a, a total path delay calculation unit 416, a delay information transmission unit 417, and a delay information request unit 418.

As illustrated in FIG. 7, the configuration of the delay information collection App 41a according to the second embodiment is different from the configuration of the delay information collection App 41 according to the first embodiment in that a delay information request unit 418 is added, and the delay information acquisition unit 411 and the path information conversion unit 415 are replaced with a delay information acquisition unit 411a and a path information conversion unit 415a, respectively.

A delay information request reception unit 414 (path information acquisition unit) acquires a delay information request transmitted from the IoT terminal control App 21 of a control device 20. The delay information request includes the path information for specifying the communication path between a control target device 10 to be controlled by the IoT terminal control App 21 and the control device 20. The delay information request reception unit 414 outputs the acquired path information to the path information conversion unit 415a.

Note that the path information may be any information as long as the information can specify the communication path between the control target device 10 and the control device 20. For example, the path information may be identification information for identifying the control target device 10 as long as the path information can specify the communication path on the basis of identification information for identifying the control target device 10, such as an IP address or a MAC address.

The path information conversion unit 415a acquires the path information output from the delay information request reception unit 414. The path information conversion unit 415a specifies the communication path between the control target device 10 to be controlled by the IoT terminal control App 21 and the control device 20 on the basis of the acquired path information. Then, the path information conversion unit 415a specifies a path ID corresponding to each of ranges constituting the specified communication path. The path ID is an identifier indicating a specific range of the communication path between the control target device 10 and the control device 20.

Note that, in the second embodiment similarly to the first embodiment, since it is assumed that a network delay is generated only in the communication device 30 as described above, the path ID corresponds to an identifier for identifying the communication device 30. Therefore, in the second embodiment, the delay information collection App 41a can recognize the network delay for each communication device 30.

The delay information collection App 41a can recognize the network delay for each range of the communication path (for each communication device 30) by acquiring the delay information in which the path ID and a delay time are associated with each other. The path information conversion unit 415a outputs the specified one or more path IDs (path ID group) to a path delay information acquisition control unit 413 and the delay information request unit 418.

The delay information request unit 418 acquires the path ID group output from the path information conversion unit 415a. The delay information request unit 418 specifies one or more path IDs (for example, the identification information for identifying the communication device 30) included in the acquired path ID group. The delay information request unit 418 transmits the delay information request to the one or a plurality of the communication devices 30 respectively corresponding to the identified path IDs.

The delay information request referred to here is control information for requesting the communication device 30 to return the delay information including the delay time (that is, the time required for communication processing performed by the communication device 30).

The delay information acquisition unit 411a acquires the delay information transmitted from each of the one or plurality of communication devices 30 in response to the delay information request transmitted from the delay information request unit 418. The delay information transmitted from the communication device 30 includes information indicating the delay time and the path ID. The delay information acquisition unit 411a stores the acquired delay information in which the information indicating the delay time and the path ID are associated with each other in the path delay information DB 412.

The path delay information acquisition control unit 413 acquires the path ID group output from the path information conversion unit 415a. The path delay information acquisition control unit 413 refers to the path delay information DB 412 and acquires the information indicating the delay time associated with each of the path IDs included in the acquired path ID group.

Note that the delay information acquisition unit 411a may directly output the acquired delay information in which the delay time and the path ID are associated with each other to the path delay information acquisition control unit 413. In this case, the path delay information acquisition control unit 413 acquires the information indicating the delay time associated with each of the path IDs included in the acquired path ID group on the basis of the information indicating the delay time and the path ID acquired from the delay information acquisition unit 411a.

Note that from which of the path delay information DB 412 and the delay information acquisition unit 411a the path delay information acquisition control unit 413 acquires the delay information may be determined in response to a request from the IoT terminal control App 21 of the control device 20, for example. For example, in a case where the request from the IoT terminal control App 21 is a request that requires more real-time property, it is preferable to directly acquire the delay information from the delay information acquisition unit 411a, otherwise, it is preferable to acquire the delay information from the path delay information DB 412.

In a case where the path ID group acquired from the path information conversion unit 415 includes a plurality of path IDs (that is, in a case where a plurality of the communication devices 30 exists in the communication path between the control target device 10 to be controlled by the IoT terminal control App 21 and the control device 20), the path delay information acquisition control unit 413 outputs the information indicating the delay time associated with each of the path IDs to a total path delay calculation unit 416.

Further, in a case where the path ID group acquired from the path information conversion unit 415a includes only one path ID (that is, only one communication device 30 exists in the communication path between the control target device 10 to be controlled by the IoT terminal control App 21 and the control device 20), the path delay information acquisition control unit 413 outputs the information indicating the delay time associated with the path ID to a delay information transmission unit 417. Alternatively, in a case where there is a request from the control device 20 to transmit the delay information to the IoT terminal control App 21 of the control device 20 without adding up the delay information, the path delay information acquisition control unit 413 outputs the delay information associated with the path ID to the delay information transmission unit 417.

The total path delay calculation unit 416 acquires the information indicating the plurality of delay times (associated with the respective path IDs) output from the path delay information acquisition control unit 413. The total path delay calculation unit 416 adds up the delay times indicated by the respective pieces of acquired information. The total path delay calculation unit 416 outputs the delay information (total delay information) indicating the added delay time to the delay information transmission unit 417.

The delay information transmission unit 417 (total delay information transmission unit) acquires the information indicating the delay time output from the path delay information acquisition control unit 413 or the total path delay calculation unit 416. The delay information transmission unit 417 transmits the acquired delay information indicating the delay time to the IoT terminal control App 21 of the control device 20.

The IoT terminal control App 21 acquires the delay information transmitted from the delay information transmission unit 417. The IoT terminal control App 21 sets a control algorithm to be executed by the IoT terminal control App 21 each time acquiring the delay information. Specifically, the IoT terminal control App 21 updates the delay information incorporated in the control algorithm each time with new delay information sequentially acquired. For example, the IoT terminal control App 21 updates the setting of the control algorithm such that the delay time based on the acquired delay information is considered.

With such a configuration, even if the delay time of the delay generated in each of the communication devices 30 existing in the communication path between the control target device 10 to be controlled and the control device 20 changes, the IoT terminal control App 21 can execute appropriate control in real time for each control target device 10 to be controlled following the change in the delay time.

### Operation of Delay Control System

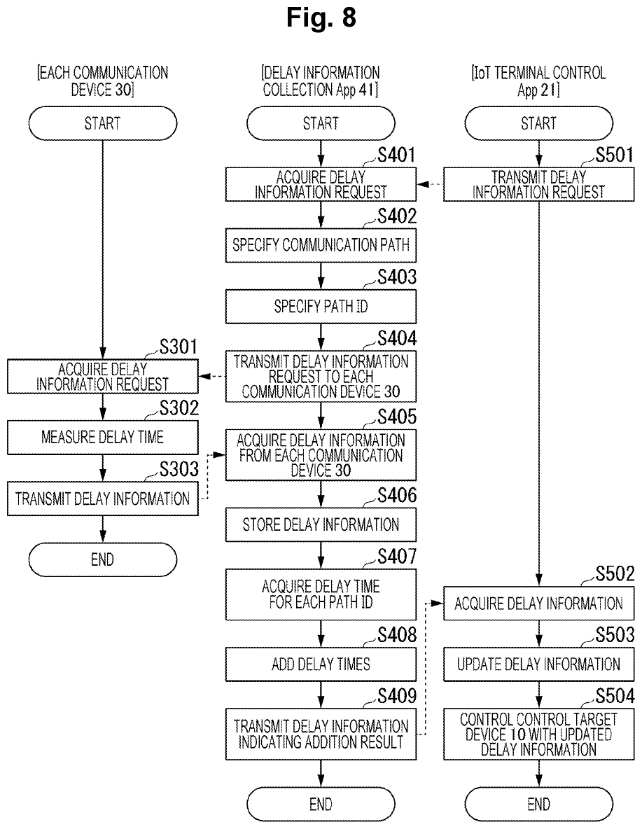

Hereinafter, an example of an operation of the delay control system 1a will be described. FIG. 8 is a flowchart illustrating an operation of the delay control system 1a according to the second embodiment of the present invention. The operation of the delay control system 1a illustrated in the flowchart of FIG. 8 is started when, for example, the IoT terminal control App 21 of the control device 20 transmits the delay information request to the delay information collection App 41a of the delay information collection device 40.

The IoT terminal control App 21 of the control device 20 transmits the delay information request to the delay information collection App 41a of the delay information collection device 40 (step S501). As described above, the delay information request includes the path information for specifying the communication path between the control target device 10 to be controlled by the IoT terminal control App 21 and the control device 20 (for example, the identification information for identifying the control target device 10).

The delay information request reception unit 414 of the delay information collection App 41a acquires the delay information request transmitted from the IoT terminal control App 21 of the control device 20 (step S301). The delay information request reception unit 414 outputs the acquired path information to the path information conversion unit 415a. The path information conversion unit 415a acquires the path information output from the delay information request reception unit 414.

The path information conversion unit 415a acquires the path information output from the delay information request reception unit 414. The path information conversion unit 415a specifies the communication path between the control target device 10 to be controlled by the IoT terminal control App 21 and the control device 20 on the basis of the acquired path information (step S402). Then, the path information conversion unit 415a specifies the path ID corresponding to each of ranges constituting the specified communication path (step S403). As described above, the path ID is an identifier indicating a specific range (the communication device 30 in the present embodiment) of the communication path between the control target device 10 and the control device 20. The path information conversion unit 415a outputs the specified one or more path IDs (path ID group) to a path delay information acquisition control unit 413 and the delay information request unit 418.

The delay information request unit 418 acquires the path ID group output from the path information conversion unit 415a. The delay information request unit 418 specifies one or more path IDs (for example, the identification information for identifying the communication device 30) included in the acquired path ID group. The delay information request unit 418 transmits the delay information request to the one or plurality of communication devices 30 respectively corresponding to the identified path IDs (step S404).

Each of the communication devices 30 acquires delay request information transmitted from the delay information collection App 41a of the delay information collection device 40 (step S301). Note that each of the communication devices 30 measures a processing time (delay time) of communication processing executed by the each communication device (step S302). Each of the plurality of communication devices 30 transmits delay information including the measured delay time to the delay information collection device 40 (step S303). As described above, the delay information includes the measured delay time and the path ID for identifying the communication device 30 that has measured the delay time.

Note that, in the present embodiment, the communication device 30 is configured to measure the delay time after acquiring the delay request information transmitted from the delay information collection App 41a of the delay information collection device 40 as described above, but the present embodiment is not limited to this configuration. For example, the communication device 30 may be configured to periodically measure the delay time and immediately transmit the latest delay time to the delay information collection device 40 in response to acquisition of the delay request information.

The delay information acquisition unit 411a acquires the delay information transmitted from each of the one or plurality of communication devices 30 in response to the delay information request transmitted from the delay information request unit 418 (step S405). The delay information transmitted from the communication device 30 includes information indicating the delay time and the path ID. The delay information acquisition unit 411a stores the acquired delay information in which the delay time and the path ID are associated with each other in the path delay information DB 412 (step S406).

The path delay information acquisition control unit 413 acquires the path ID group output from the path information conversion unit 415a. The path delay information acquisition control unit 413 refers to the path delay information DB 412 and acquires the information indicating the delay time associated with each of the path IDs included in the acquired path ID group (step S407).

The path delay information acquisition control unit 413 outputs the information indicating the delay time associated with each path ID to the total path delay calculation unit 416.

The total path delay calculation unit 416 acquires the information indicating the plurality of delay times (associated with the respective path IDs) output from the path delay information acquisition control unit 413. The total path delay calculation unit 416 adds up the delay times indicated by the respective pieces of acquired information (step S408). The total path delay calculation unit 416 outputs the delay information (total delay information) indicating the added delay time to the delay information transmission unit 417.

The delay information transmission unit 417 acquires the information indicating the delay time output from the path delay information acquisition control unit 413 or the total path delay calculation unit 416. The delay information transmission unit 417 transmits the acquired delay information indicating the delay time to the IoT terminal control App 21 of the control device 20 (step S409).

The IoT terminal control App 21 of the control device 20 acquires the delay information transmitted from the delay information transmission unit 417 (step S502).

The IoT terminal control App 21 sets a control algorithm to be executed by the IoT terminal control App 21 each time acquiring the delay information. Specifically, the IoT terminal control App 21 updates the delay information incorporated in the control algorithm each time with the new delay information sequentially acquired (step S503).

For example, the IoT terminal control App 21 updates the setting of the control algorithm such that the delay time based on the acquired delay information is considered.

The IoT terminal control App 21 controls the control target device 10 by the control algorithm using the updated delay information (step S504). Thus, the operation of the delay control system 1a illustrated in the flowchart of FIG. 8 ends.

As described above, the delay control system 1a according to the second embodiment of the present invention is a system for the control device 20 to remotely control the control target device 10 such as the IoT terminal in consideration of the delay generated in the communication path. In general, since the control device 20 is a device managed by the user, the control device does not have an interface capable of directly communicating and connecting with the communication device 30 managed by the telecommunications operator and present in the communication path.

However, the delay control system 1a according to the second embodiment of the present invention includes the delay information collection device 40 that collects the delay information from each communication device 30 instead of the device managed by the user. With such a configuration, the delay control system 1a according to the second embodiment of the present invention can perform remote control of the control target device 10 in consideration of the delay generated in the communication path even in the case where the control device 20 cannot directly communicate with the communication device 30 existing in the communication path between the control device 20 and the control target device 10.

Further, in the delay control system 1a according to the second embodiment of the present invention, the delay information is transmitted from each of the communication devices 30 to the delay information collection App 41a by pull-type information transmission in response to the request from the delay information collection App 41a. With such a configuration, the delay control system 1a according to the second embodiment of the present invention can be configured to acquire only the delay information of a necessary communication device 30 at necessary timing, for example. As a result, the delay control system 1a according to the second embodiment can reduce a storage capacity of a path delay information DB 412 or reduce an amount of communication between each of the communication devices 30 and a delay information collection device 40, for example.

### Third Embodiment

Hereinafter, a delay control system 1 according to a third embodiment of the present invention will be described.

In the delay control system 1 according to the first embodiment and the delay control system 1a according to the second embodiment described above, the path ID corresponds to the identification information for identifying the communication device 30, and thus it can be said that the systems are configured to manage the delay information in units of devices (communication devices 30). In contrast, the delay control system according to the third embodiment to be described below is configured to manage delay information in units of sections between devices (in a communication path).

### Configuration of Delay Control System

An overall configuration diagram of the delay control system according to the third embodiment is similar to the overall configuration diagram of the above-described delay control system 1 according to the first embodiment illustrated in FIG. 1, and thus description thereof will be omitted.

### Configuration of Delay Information Collection App

A configuration of a delay information collection App 41b of a delay information collection device 40 in the third embodiment can be basically similar to the configuration of the above-described delay information collection App 41 in the first embodiment illustrated in FIG. 2 or the configuration of the above-described delay information collection App 41a in the second embodiment illustrated in FIG. 7. Therefore, description of a basic configuration of the third delay information collection App 41b will be omitted, and a range having a configuration different from those of the first embodiment and the second embodiment will be mainly described below.

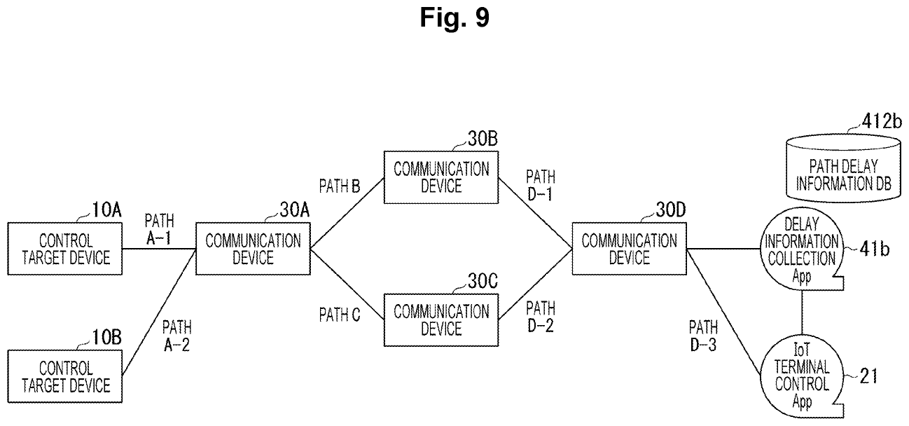

Hereinafter, delay information collection processing by the delay information collection App 41b of the delay information collection device 40 will be described with a specific example. FIG. 9 is a diagram illustrating an example of a configuration of a communication network and the delay control system.

As illustrated in FIG. 9, an IoT terminal control App 21 can control a control target device 10A and a control target device 10B. Furthermore, as illustrated in FIG. 3, communication devices 30A to 30D exist in the communication paths between the IoT terminal control App 21 (the control device 20), and the control target device 10A and the control target device 10B.

As illustrated in FIG. 9, the control target device 10A and the control target device 10B are connected to the communication device 30A. The communication device 30A is connected to the communication device 30B and the communication device 30C. The communication device 30B and the communication device 30C are connected to the communication device 30D. The communication device 30D is connected to the IoT terminal control App 21 (control device 20) and the delay information collection App 41b (delay information collection device 40). The delay information collection App 41b includes a path delay information DB 412b.

Further, identification information (path ID) is assigned to each section constituting a communication path between the IoT terminal control App 21 (control device 20), and the control target device 10A and the control target device 10B.

As illustrated in FIG. 9, the path ID assigned to the section between the control target device 10A and the communication device 30A is “path A-1”, the path ID assigned to the section between the control target device 10B and the communication device 30A is “path A-2”, the path ID assigned to the section between the communication device 30A and the communication device 30B is “path B”, the path ID assigned to the section between the communication device 30A and the communication device 30C is “path C”, the path ID assigned to the section between the communication device 30B and the communication device 30D is “path D-1”, the path ID assigned to the section between the communication device 30C and the communication device 30D is “path D-2”, and the path ID assigned to the section between the communication device 30D and the IoT terminal control App 21 is “path D-3”.

An alphabetic character described subsequent to the character string “path” of the path ID indicates the communication device 30 that manages the delay information indicating a delay time generated in the path ID.

Specifically, the communication device 30A manages the delay information indicating the delay time generated in the section of “path A-1” and the section of “path A-2” of the communication path, the communication device 30B manages the delay information indicating the delay time generated in the section of “path B” of the communication path, the communication device 30C manages the delay information indicating the delay time generated in the section of “path C” of the communication path, and the communication device 30D manages the delay information indicating the delay time generated in the section of “path D-1”, the section of “path D-2”, and the section of “path D-3”.

The path delay information DB 412b stores in advance information (path information master) in which identification information for identifying the control target device 10 and information (path ID group) for identifying each of one or a plurality of sections constituting the communication path between the control target device 10 and the control device 20 are associated with each other. Here, it is assumed that the path information master is acquired in advance by, for example, another system (not illustrated) or the like and stored in the path delay information DB 412b.

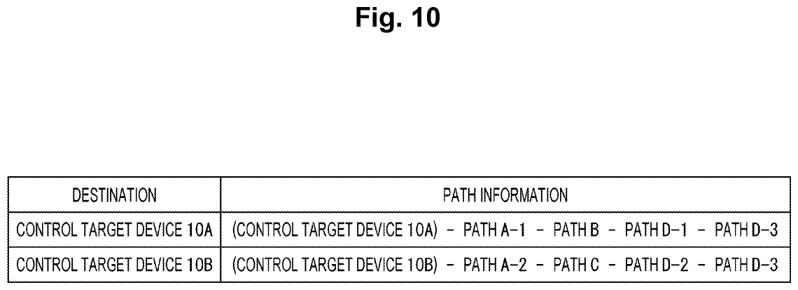

FIG. 10 is a diagram illustrating an example of the path information master stored in the path delay information DB 412b according to the third embodiment of the present invention. As illustrated in FIG. 10, for example, the path ID group indicating the communication path of (control target device 10A)—“path A-1”—“path B”—“path D-1”—“path D-3” is associated with the identification information (the character string “control target device 10A” in FIG. 10) for identifying the control target device 10A. In FIG. 10, each of the character strings of “path A-1”, “path B”, “path D-1”, and “path D-3” is the path ID.

Further, the path delay information DB 412b stores information in which the path ID, the identification information of the communication device that manages the delay time of the delay generated in the section of the communication path to which the path ID is assigned, and the delay time are associated with one another. The delay information is sequentially acquired from each of the communication devices 30 and updated by the delay information collection App 41b.

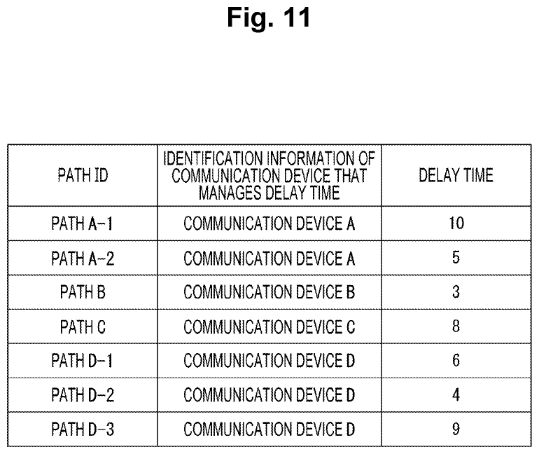

FIG. 11 is a diagram illustrating an example of the delay information stored in the path delay information DB 412b according to the third embodiment of the present invention. As illustrated in FIG. 11, the identification information of the communication device 30 that manages the delay time and information indicating the delay time are associated with the path ID.

The information indicating the delay time is, for example, information indicating the delay time of the delay generated in the communication processing executed by each communication device 30. As illustrated in FIG. 11, for example, the delay time of “10” is associated with the path ID of “path A-1”. This indicates that the delay time (at that time) of the delay generated in the section of “path A-1” of the communication path is 10 (for example, 10 milliseconds). Furthermore, as illustrated in FIG. 11, for example, the delay time of “3” is associated with the path ID of “communication device B”. This indicates that the delay time (at that time) of the delay generated in the section of “path B” of the communication path is 3 (for example, 3 milliseconds).

Further, the delay information including the delay times associated with the section of “path A-1” and the section of “path A-2” is transmitted from the communication device 30A that manages the delay times to the delay information collection App 41b and is sequentially updated, the delay information including the delay time associated with the section of “path B” is transmitted from the communication device 30B that manages the delay time to the delay information collection App 41b and is sequentially updated, the delay information including the delay time associated with the section of “path C” is transmitted from the communication device 30C that manages the delay time to the delay information collection App 41b and is sequentially updated, and the delay information including the delay times associated with the sections of “path D-1”, “path D-2” and “path D-3” is transmitted from the communication device 30D that manages the delay times to the delay information collection App 41b and is sequentially updated.

Hereinafter, a flow of delay information collection processing will be described. First, the IoT terminal control App 21 transmits the path information including the identification information for identifying the control target device 10 to be controlled to the delay information collection App 41. As an example, here, it is assumed that the IoT terminal control App 21 transmits the path information including the identification information indicating the control target device 10A to the delay information collection App 41.

The delay information collection App 41b acquires the path information transmitted from the IoT terminal control App 21. The delay information collection App 41b specifies the identification information (identifying the control target device 10) included in the acquired path information. The delay information collection App 41 refers to the path delay information DB 412b and acquires the path ID group corresponding to the specified identification information.

As described above, here, the identification information included in the path information is the identification information indicating the control target device 10A. The delay information collection App 41b acquires “(control target device 10A)—path A-1—path B—path D-1—path D-3”, which is the path ID group corresponding to the control target device 10A illustrated in FIG. 10, for example.

Next, the delay information collection App 41b refers to the path delay information DB 412b and acquires the information indicating the delay time corresponding to each of the path IDs included in the acquired path ID group. Specifically, the delay information collection App 41b acquires, for example, “10” that is a value of the delay time corresponding to “path A-1”, “3” that is a value of the delay time corresponding to “path B”, “6” that is a value of the delay time corresponding to “path D-1”, and “9” that is a value of the delay time corresponding to “path D-3” illustrated in FIG. 11.

The delay information collection App 41b adds up the values of the delay times included in the acquired delay information. Specifically, the delay information collection App 41b obtains the value of “28” that is a result of adding up the values of the delay times. The delay information collection App 41b transmits the delay information (total delay information) indicating the added delay time to the IoT terminal control App 21.

The IoT terminal control App 21 acquires the delay information transmitted from the delay information collection App 41b. The IoT terminal control App 21 updates the delay information incorporated in the control algorithm each time with the acquired new delay information. Specifically, the IoT terminal control App 21 updates the setting of the control algorithm so as to control the control target device 10A in consideration of the value of “28” (for example, 28 milliseconds) that is the delay time indicated by the acquired delay information.

With such a configuration, even if the delay time of the delay generated in each of the section of “path A-1”, the section of “path B”, the section of “path D-1”, and the section of “path D-3” constituting the communication path between the control target device 10A to be controlled and the control device 20 changes, the IoT terminal control App 21 can execute appropriate control of the control target device 10A in real time following the change in the delay time.

### Operation of Delay Control System

The operation of the delay control system in the third embodiment can be basically similar to the above-described operation of the delay control system 1 in the first embodiment illustrated in the flowchart in FIG. 6 or the above-described operation of the delay control system 1a in the second embodiment illustrated in the flowchart in FIG. 8. Therefore, description of the operation of the third delay control system is omitted.

As described above, the delay control system according to the third embodiment of the present invention is a system for the control device 20 to remotely control the control target device 10 such as the IoT terminal in consideration of the delay generated in the communication path. In general, since the control device 20 is a device managed by the user, the control device does not have an interface capable of directly communicating and connecting with the communication device 30 managed by the telecommunications operator and present in the communication path.

However, the delay control system according to the third embodiment of the present invention includes the delay information collection device 40 that collects the delay information from each communication device 30 instead of the device managed by the user. With such a configuration, the delay control system according to the third embodiment of the present invention can perform remote control of the control target device 10 in consideration of the delay generated in the communication path even in the case where the control device 20 cannot directly communicate with the communication device 30 existing in the communication path between the control device 20 and the control target device 10.

In addition, the delay control system according to the third embodiment of the present invention is configured to manage the delay information in units of sections between the devices (in the communication path) instead of managing the delay information in units of the communication devices 30. With such a configuration, the delay control system according to the third embodiment of the present invention can make it easier for the control device 20 to remotely control the control target device 10 such as an IoT terminal in consideration of not only the delay time generated in the communication device 30 but also the delay time generated in the communication path between the devices.

### Modification

Hereinafter, some variations regarding the network configuration (connection form) of the control target device 10, the communication device 30, the delay information collection App 41 (delay information collection device 40), and the IoT terminal control App 21 (control device 20) will be described. The network configuration to be described below is applicable to any of the above-described delay control systems in the first to third embodiments.

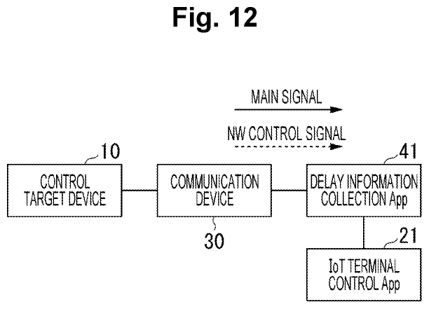

Each of FIGS. 12 to 20 is a block diagram illustrating an example of the network configurations of the delay control systems according to the embodiments of the present invention. In the following description, the control target device 10 is, for example, an IoT terminal such as a drone, a sensor, or an actuator. Furthermore, the control device 20 is, for example, an information processing device such as a general-purpose computer. Furthermore, the communication device 30 is, for example, a communication device such as a radio base station, a switch, an OLT, or an ONU. Furthermore, the delay information collection device 40 is an IoT terminal such as a sensor or an actuator. Furthermore, the control device 20 is, for example, an information processing device such as a general-purpose computer.

FIG. 12 illustrates an example of a network configuration in a case where a main signal and a network control signal (hereinafter referred to as an “NW control signal”) transmitted and received between the control target device 10 and the IoT terminal control App 21 (control device 20) are transmitted through the same communication path. The network control signal referred to here is, for example, the delay information transmitted from the communication device 30 to the delay information collection App 41 (delay information collection device 40), the delay information request transmitted from the delay information collection App 41 (delay information collection device 40) to the communication device 30, and the like.

Furthermore, FIG. 12 illustrates the communication path in the case where the delay information collection App 41 (delay information collection device 40) exists in the communication path between the control target device 10 and the IoT terminal control App 21 (control device 20). Therefore, in the network configuration illustrated in FIG. 12, the main signal transmitted and received between the control target device 10 and the control device 20 is transmitted and received via the delay information collection device 40.

Note that the IoT terminal control App 21 and the delay information collection App 41 may be applications executed in the same device. That is, the control device 20 and the delay information collection device 40 may be an integrated device.

Furthermore, FIG. 12 illustrates a network configuration in a case where only one communication device 30 exists in the communication path between the control target device 10 and the IoT terminal control App 21 (control device 20).

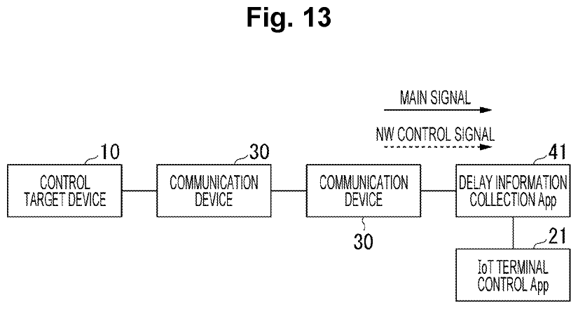

In contrast, as in the network configuration illustrated in FIG. 13, a plurality of the communication devices 30 may exist in the communication path between the control target device 10 and the delay information collection App 41 (delay information collection device 40). It is conceivable that the case where the plurality of communication devices 30 is present in the communication path between the control target device 10 and the delay information collection device 40 is, for example, a case where the control target device 10 and the delay information collection device 40 are connected via a core network.

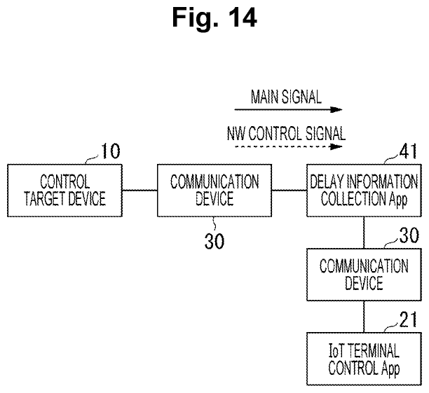

Furthermore, as in the network configuration illustrated in FIG. 14, the communication device 30 may exist in the communication path between the IoT terminal control App 21 (control device 20) and the delay information collection App 41 (delay information collection device 40).

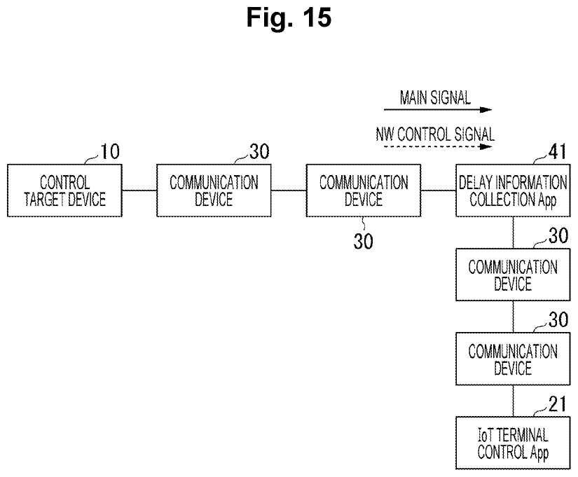

Furthermore, as in the network configuration illustrated in FIG. 15, a plurality of the communication devices 30 may exist not only in the communication path between the control target device 10 and the delay information collection App 41 (delay information collection device 40) but also in the communication path between the IoT terminal control App 21 (control device 20) and the delay information collection App 41 (delay information collection device 40). It is conceivable that the case where the plurality of communication devices 30 is present in the communication path between the control device 20 and the delay information collection device 40 is, for example, a case where the control device 20 and the delay information collection device 40 are connected via a core network.

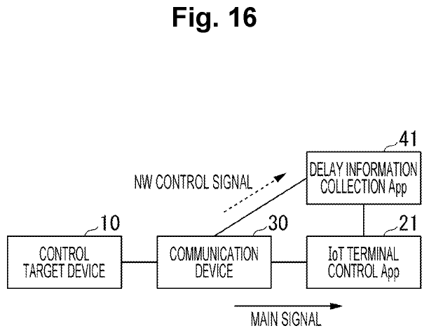

FIG. 16 illustrates an example of a network configuration in a case where the main signal and the NW control signal transmitted and received between the control target device 10 and the IoT terminal control App 21 (control device 20) are transmitted through different communication paths. In the case of the network configuration illustrated in FIG. 16, the delay information collection App 41 (delay information collection device 40) does not exist in the communication path between the control target device 10 and the IoT terminal control App 21 (control device 20). Therefore, in this case, the main signal transmitted and received between the control target device 10 and the control device 20 is transmitted and received without passing through the delay information collection device 40.

Furthermore, FIG. 16 illustrates a network configuration in a case where only one communication device 30 exists in the communication path between the control target device 10 and the IoT terminal control App 21 (control device 20).

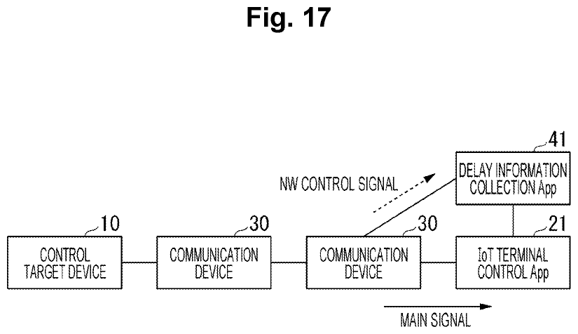

In contrast, as in the network configuration illustrated in FIG. 17, a plurality of the communication devices 30 may exist in the communication path between the control target device 10 and the IoT terminal control App 21 (control device 20). It is conceivable that the case where the plurality of communication devices 30 is present in the communication path between the control target device 10 and the control device 20 is, for example, a case where the control target device 10 and the control device 20 are connected via a core network.

Further, FIG. 17 illustrates a network configuration in a case where the delay information collection App 41 (delay information collection App 40) is communicatively connected to one communication device 30. Therefore, in the network configuration illustrated in FIG. 17, the NW control signal transmitted from each of the communication devices 30 to the delay information collection App 41 and the NW control signal transmitted from the delay information collection App 41 to each of the communication devices 30 are transmitted via one communication device 30 communicatively connected to the delay information collection App 41. Then, among the plurality of communication devices 30, the NW control signal is transmitted through the same communication path as the main signal.

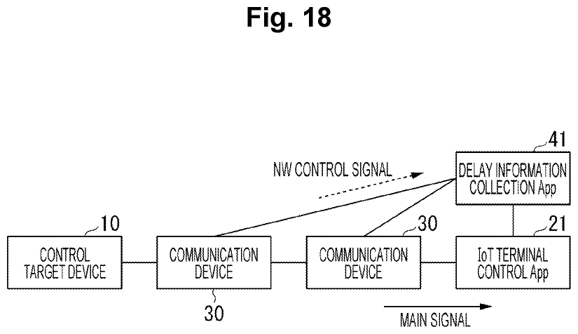

Meanwhile, as in the network configuration illustrated in FIG. 18, the delay information collection App 41 (delay information collection App 40) and each of the plurality of communication devices 30 may be directly communicatively connected to each other. In the network configuration illustrated in FIG. 18, the NW control signal transmitted from each of the communication devices 30 to the delay information collection App 41 and the NW control signal transmitted from the delay information collection App 41 to each of the communication devices 30 are directly transmitted without passing through other devices. Therefore, in the network configuration illustrated in FIG. 18, the main signal transmitted and received between the control target device 10 and the IoT terminal control App 21 (control device 20) and the NW control signal transmitted and received between the delay information collection App 41 (delay information collection device 40) and each of the communication devices 30 are all transmitted through different communication paths.

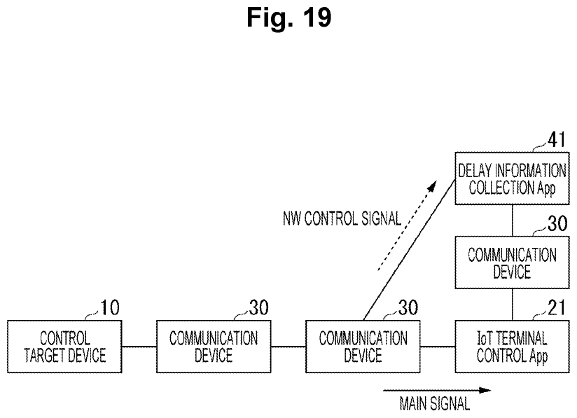

Furthermore, as in the network configuration illustrated in FIG. 19, the communication device 30 may exist in the communication path between the IoT terminal control App 21 (control device 20) and the delay information collection App 41 (delay information collection device 40).

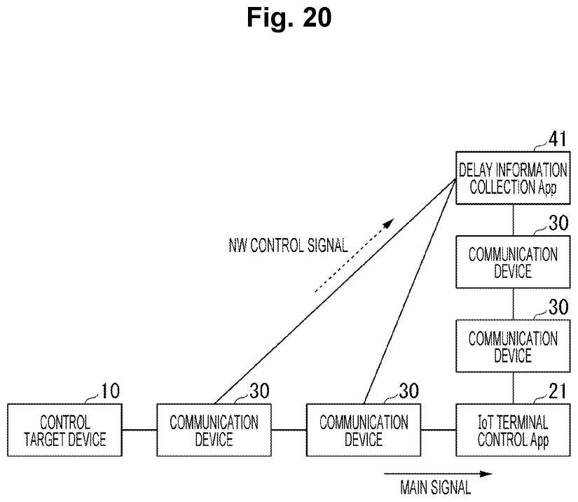

Furthermore, as in the network configuration illustrated in FIG. 20, a plurality of the communication devices 30 may exist not only in the communication path between the control target device 10 and the IoT terminal control App 21 (control device 20) but also in the communication path between the IoT terminal control App 21 (control device 20) and the delay information collection App 41 (delay information collection device 40). It is conceivable that the case where the plurality of communication devices 30 is present in the communication path between the control device 20 and the delay information collection device 40 is, for example, a case where the control device 20 and the delay information collection device 40 are connected via a core network.

Further, the network configuration illustrated in FIG. 20 is a configuration in which the delay information collection App 41 (delay information collection App 40) and each of the plurality of communication devices 30 are directly communicatively connected, similarly to the network configuration illustrated in FIG. 18.

According to the above-described embodiments, the delay information collection device includes the path information acquisition unit, the delay information acquisition unit, and the delay information transmission unit. For example, the delay information collection device is the delay information collection device 40 in the embodiments, the path information acquisition unit is the delay information request reception unit 414 in the embodiments, the delay information acquisition unit is the delay information acquisition unit 411 and the delay information acquisition unit 411a in the embodiments, and the delay information transmission unit is the delay information transmission unit 417 in the embodiments.

The above-described path information acquisition unit acquires the path information regarding the communication path between the control target device and the control device. For example, the control target device is the control target device 10 in the embodiments, and the control device is the control device 20 in the embodiments. The above-described delay information acquisition unit acquires the delay information indicating the delay time of communication generated in the communication path from one or a plurality of the communication devices existing in the communication path. For example, the communication device is the communication device 30 in the embodiments. The above-described delay information transmission unit transmits the total delay information indicating the total delay times based on the delay information acquired by the delay information acquisition unit to the control device that controls the control target device on the basis of the total delay information.

The path information may include the identification information for identifying the control target device. In this case, the delay information acquisition unit may acquire the delay information from one or a plurality of the communication devices existing between the control target device identified by the identification information and the control device.

Note that the above-described delay information collection device may further include the delay information request unit. For example, the delay information request unit is the delay information request unit 418 in the embodiments. In this case, the delay information request unit may transmit the transmission request of the delay information to the communication device.

Note that the delay time may include a processing time of processing executed by the communication device.

Note that the delay time may be a time indicating a delay generated in a specific section of the communication path managed by the communication device.

Furthermore, according to the above-described embodiments, the delay control system includes the control device and the delay information collection device. For example, the delay control system is the delay control system 1 and the delay control system 1a in the embodiments, the control device is the control device 20 in the embodiments, and the delay information collection device is the delay information collection device 40 in the embodiments.

The above-described control device includes the path information transmission unit, the total delay information acquisition unit, and the control unit. The above-described path information transmission unit transmits, to the delay information collection device, the path information regarding the communication path between the control target device to be controlled and its own device. The above-described total delay information acquisition unit acquires, from the delay information collection device, the total delay information indicating the total of delay times of communication generated in the communication path. The above-described control unit controls the control target device on the basis of the total delay information acquired by the total delay information acquisition unit.

The above-described delay information collection device includes the path information acquisition unit, the delay information acquisition unit, and the total delay information transmission unit. For example, the path information acquisition unit is the delay information request reception unit 414 in the embodiments, the delay information acquisition unit is the delay information acquisition unit 411 and the delay information acquisition unit 411a in the embodiments, and the total delay information transmission unit is the delay information transmission unit 417 in the embodiments.

The path information acquisition unit acquires the path information transmitted from the control device. The above-described delay information acquisition unit acquires the delay information indicating the delay time from one or a plurality of the communication devices existing in the communication path. For example, the communication device is the communication device 30 in the embodiments. The total delay information transmission unit transmits the total delay information indicating the total delay times based on the delay information acquired by the delay information acquisition unit to the control device.

A part of the control target device 10, the control device 20, the communication device 30, and the delay information collection device 40 in the above-described embodiments may be implemented by a computer. In that case, a program for implementing the functions may be recorded in a computer-readable recording medium, and the functions may be implemented by loading the program recorded in this recording medium to a computer system, and executing the program. Note that, the “computer system” referred to here includes an OS and hardware such as peripheral equipment. In addition, the “computer-readable recording medium” refers to a portable medium such as a flexible disk, a magneto-optical disc, a ROM, or a CD-ROM or a storage device such as a hard disk included in the computer system.

Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing a part of the function described above, may be implemented in a combination with a program already recorded in a computer system, or may be implemented with a programmable logic device such as a field programmable gate array (FPGA).

Although the embodiments of the present invention have been described in detail with reference to the drawings, specific configurations are not limited to the embodiments, and include design and the like within the scope of the present invention without departing from the gist of the present invention.

### REFERENCE SIGNS LIST

1, 1a Delay control system
10, 10A, 10B Control target device
20 Control device
21 IoT terminal control application
30, 30-1, 30-2, 30A, 30B, 30C, 30D Communication device
40 Delay information collection device
41 Delay information collection application
411, 411a Delay information acquisition unit
412 Path delay information database
413 Path delay information acquisition control unit
414 Delay information request reception unit
415, 415a Path information conversion unit
416 Total path delay calculation unit
417 Delay information transmission unit
418 Delay information request unit

1. A delay information collection device comprising:
a path information acquisition unit, including one or more processors, configured to acquire path information regarding a communication path between a control target device and a control device;
a delay information acquisition unit, including one or more processors, configured to acquire delay information indicating a delay time of communication generated in the communication path from one or a plurality of communication devices existing in the communication path; and
a delay information transmission unit, including one or more processors, configured to transmit total delay information indicating a total of the delay times based on the delay information acquired by the delay information acquisition unit to the control device that controls the control target device on a basis of the total delay information.

2. The delay information collection device according to claim 1, wherein
the path information includes identification information for identifying the control target device, and
the delay information acquisition unit is configured to acquire the delay information from the one or plurality of communication devices existing between the control target device identified with the identification information and the control device.

3. The delay information collection device according to claim 1, further comprising:
a delay information request unit, including one or more processors, configured to transmit a transmission request of the delay information to the communication device.

4. The delay information collection device according to claim 1, wherein
the delay time includes a processing time of processing executed by the communication device.

5. The delay information collection device according to claim 1, wherein
the delay time is a time indicating a delay generated in a specific section of the communication path managed by the communication device.

6. A delay control system comprising: a control device and a delay information collection device,
the control device including:
a path information transmission unit, including one or more processors, configured to transmits, to the delay information collection device, path information regarding a communication path between a control target device to be controlled and the control device;
a total delay information acquisition unit, including one or more processors, configured to acquires, from the delay information collection device, total delay information indicating a total of delay times of communication generated in the communication path; and
a control unit, including one or more processors, configured to controls the control target device on a basis of the total delay information acquired by the total delay information acquisition unit, and
the delay information collection device including:
a path information acquisition unit, including one or more processors, configured to acquires the path information transmitted from the control device;
a delay information acquisition unit, including one or more processors, configured to acquires the delay information indicating the delay time from one or a plurality of communication devices existing in the communication path; and
a total delay information transmission unit, including one or more processors, configured to transmits, to the control device, the total delay information indicating the total of the delay times based on the delay information acquired by the delay information acquisition unit.

7. A delay information collection method by a computer of a delay information collection device, the delay information collection method comprising:
acquiring path information regarding a communication path between a control target device and a control device;
acquiring delay information indicating a delay time of communication generated in the communication path from one or a plurality of communication devices existing in the communication path; and
transmitting total delay information indicating a total of the delay times based on the delay information to the control device that controls the control target device on a basis of the total delay information.

8. A program for causing a computer to execute:
operations of the delay information collection method according to claim 7.

9. The delay information collection method according to claim 7, wherein
the path information includes identification information for identifying the control target device, and the method further comprises:
acquiring the delay information from the one or plurality of communication devices existing between the control target device identified with the identification information and the control device.

10. The delay information collection method according to claim 7, further comprising:
transmitting a transmission request of the delay information to the communication device.

11. The delay information collection method according to claim 7, wherein
the delay time includes a processing time of processing executed by the communication device.

12. The delay information collection method according to claim 7, wherein
the delay time is a time indicating a delay generated in a specific section of the communication path managed by the communication device.
